(19) United States
(12) Patent Application Publication
(10) Pub. No.: US 2023/0248091 A1
(43) Pub. Date: Aug. 10, 2023

(54) PERSONAL SAFETY DEVICE AND METHOD OF USE

(71) Applicant: Personal Safety Labs Inc., Bountiful, UT (US)

(72) Inventor: Kenneth Dennis Hoffmann, Bountiful, UT (US)

(21) Appl. No.: 17/667,981

(22) Filed: Feb. 9, 2022

(51) Int. Cl. A41D 19/00

(52) U.S. Cl. CPC A41D 19/002

(57) ABSTRACT

A personal safety device including a wearable garment, a housing disposed in the wearable garment, a retractable blade disposed in the housing wherein the retractable blade having a retracted position and extended position, and a biasing element disposed in the housing and biasing the retracted blade to the retracted position.

### BACKGROUND

Each year, and increasingly, a staggering number of people are assaulted or become a potential or actual victim of violent crime. Women especially are particularly vulnerable. According to an FBI release on crime statistics, in 2019 there were an estimated 1.2 million violent crimes of which more than half were committed against women. Many of these women having been subject to awful violent crimes including rape, sexual assault, and robbery. Stalking, or even threatening harm, is another major concern. Many people, necessarily or even accidently, find themselves in potentially dangerous situation in which they are confronted by an attacker. Defending oneself is a personal right and in these situations is of extreme importance.

The subject matter claimed herein is not limited to implementations that solve any disadvantages or that operate only in circumstances such as those described above. Rather, this background is only provided to illustrate one exemplary technology area where some implementations described herein may be practiced.

### BRIEF SUMMARY

In some embodiments, an apparatus for personal safety includes a wearable garment having an opening, a housing disposed in the wearable garment, a retractable blade disposed in the housing, wherein the retractable blade has a retracted position and an extended position, and wherein in the extended position, the retractable blade protrudes through the opening, and a biasing element disposed in the housing, the biasing element biasing the retractable blade to the retracted position.

In other embodiments, an apparatus for personal safety includes a glove having an opening, a retractable blade attached to a handle and disposed in a pocket inside the glove, wherein the retractable blade has a retracted position and an extended position, and wherein in the extended position, the retractable blade protrudes through the opening, and a lever arm attached to the retractable blade, wherein the lever arm protrudes outside of the glove when the retractable blade is in retracted position.

In yet other embodiments, a method for activating a personal safety device is provided, activating a lever mechanism for sliding a retractable blade out of a housing, wherein the housing is attached to a wearable garment, and wherein activating the lever mechanism extends a biasing element, and retracting the retractable blade inside the housing when the lever mechanism is deactivated, wherein the biasing element is biasing the retractable blade to a retracted position.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1-1 is a plan view of a personal safety device, according to at least some embodiments of the present disclosure.

FIG. 1-2 is a plan view of an activated personal safety device, according to at least some embodiments of the present disclosure.

FIG. 2-1 is a cross-sectional view of a housing of a personal safety device, according to at least some embodiments of the present disclosure.

FIG. 2-2 is a cross-sectional view of a housing of a personal safety device, according to at least some embodiments of the present disclosure.

FIG. 3-1 is a cross-sectional view of a housing of a personal safety device, according to at least some embodiments of the present disclosure.

FIG. 3-2 is a cross-sectional view of a housing of a personal safety device, according to at least some embodiments of the present disclosure.

FIG. 4 is a plan view of a securing mechanism, according to some embodiments of the present disclosure.

FIG. 5 is a plan view of another securing mechanism, according to some embodiments of the present disclosure.

FIG. 6 is a plan view of yet another securing mechanism, according to some embodiments of the present disclosure.

FIG. 7 is a plan view of one aspect of a personal safety device, according to at least some embodiments of the present disclosure.

FIG. 8-1 is a plan view of one aspect of a personal safety device, according to at least some embodiments of the present disclosure.

FIG. 8-2 is a plan view of one aspect of a personal safety device, according to at least some embodiments of the present disclosure.

### DETAILED DESCRIPTION

This disclosure generally relates to personal safety devices. More particularly, this disclosure relates to a wearable safety device that is safe to carry and readily available to use. Conventional personal safety devices often include pepper spray, mace, stun guns, alarms, and pocketknives. However, these conventional personal safety devices are often stored in a bag or a pocket, and it may take too much time to reach them when an attack happens, resulting in harm to a victim. Furthermore, there is nothing stopping the attacker to seize any of these devices away from the victim and use it against the victim themselves. A personal safety device and method of using it is provided herein to address these issues.

In some embodiments a personal safety apparatus, according to the present disclosure may include a wearable garment having an opening, a housing disposed in the wearable garment, and a retractable blade disposed in the housing. In some embodiments, the retractable blade may be spring-loaded. For example, the wearable garment may be a glove, or other type of garment worn on or around a hand or a palm. In some embodiments, the glove may cover all fingers fully. In some embodiments the glove may have half-finger coverage, or fingerless coverage. In some embodiments, the glove may include any combination of at least two of full finger coverage, half-finger coverage, and fingerless coverage.

In some embodiments the glove may be easily recognized due to its highly noticeable color. For example, the color may be bright fluorescent green, yellow, red, or any other bright and highly noticeable color. In some embodiments, the wearable garment may also embody small flashing lights, making it easily recognizable. In some embodiments, the garment may be unnoticeable and generally match the color of one's skin. In some embodiments, the garment may be easily secured to its place. For example, the garment can be secured to a user's wrist with a hook and loop connector than may be wrapped around the user's wrist (e.g., a Velcro connector). In some embodiments, the garment can be secured to a user's wrist with a mechanical lock, or a digital code lock.

In some embodiments, the garment may include a pocket for a housing. In some embodiments, the housing may be rigidly fixed inside the pocket to prevent the housing from being removed. In some embodiments, the rigidly fixed housing may only be removed inside of the pocket when the garment is removed. In some embodiments, the housing may be rigidly fixed outside of the garment. In some embodiments, the housing is rigidly fixed to the garment with a hook and loop connector, such as a Velcro connection. The housing may generally be fixed on a palm side of a hand and may be oriented substantially tilted in relation to the fingers and substantially parallel to the thumb. This may help to improve the speed of deployment of the blade. The orientation of the housing may allow fingers to easily curl into a fist around the housing, so that the housing is gripped by the user's fingers. In some embodiments, the housing may be completely secured inside the garment. In some embodiments, the housing protrudes outside of the garment.

In some embodiments, a blade is disposed in the housing. In some embodiments, the blade is disposed substantially parallel to a palm. For example, the blade may be a retractable blade having a retracted position and an extended position. As discussed herein, the blade may be spring-loaded, which may help to increase the safety for the user as well as the ease of implementation. In some embodiments, the retractable blade may be configured to protrude outside of the housing when in extended position. In some embodiments, the garment having an opening substantially on the webbing area of the palm, between thumb and index finger, may allow the blade within the housing to protrude outside of the housing through the opening when in extended position. The housing and the angle of the opening in the house, according to some embodiments, will also prevent accidental injury to the user even when the blade is in extended position.

In accordance with some embodiments of the present disclosure, the blade may have only one sharp side. For example, the blade may have a sharp side on the side that faces the user's fingers and a dull blade on the side that faces the user's thumb. In some embodiments, the blade has a hooked edge. In some embodiments, the blade may have two sharp sides. In some embodiments, the blade may be straight on one side and non-linear on another side. For example, the blade may be curved on the side near the user's thumb and straight near the user's fingers.

In some embodiments, a biasing element may be disposed in the housing and may bias the retractable blade to the retracted position. For example, the biasing element may be a compression spring, extension spring, torsion spring, constant force spring, coil spring, leaf spring, any other type of spring, an elastically deformable material, any other biasing element, and combinations thereof. For example, the biasing element may be a pre-compressed spring positioned at a back-part of the housing and providing biasing force to the blade to keep it inside of the housing. In another example, the biasing element is a pre-extended spring positioned at the front-part of the housing and providing biasing force to the blade to keep it inside of the housing. In both examples, the biasing element applies a force to the blade toward the back-part of the housing.

In some embodiments, the biasing element is a system of magnets. For example, the biasing element may include a first magnet located at the back-part of the housing and having its positive pole against the back-part of the blade, wherein the blade may have a second magnet having its negative pole against the first magnet. The biasing element may further include a third magnet located at the front-part of the blade having its positive pole against the front-part of the housing, wherein the front-part of the housing may include a fourth magnet having its positive pole against the front-part of the blade. The resulting system of magnets providing magnetic repulsion force for moving the blade to extended position and attraction force for moving the blade to retracted position.

In some embodiments, the biasing element may be a compressible gas in a cylinder positioned at the front-part of the housing and providing a biasing force towards the blade. As the gas in the cylinder is compressed, the pressure in the cylinder increases, providing an increasing force from the biasing element.

The biasing element may follow Hooke's law and exhibit a linear force response to displacement along a longitudinal axis of the biasing element. In some embodiments, the biasing element has an exponential biasing force vs. displacement curve. In this manner, the biasing element may apply an increased biasing force on the retractable blade when the lever mechanism is activated. For example, the biasing element may include a progressive spring, a compressible gas, or other material that causes the force generated by the biasing element to increase exponentially relative to the displacement along a longitudinal axis of the biasing element.

In some embodiments, the personal safety device may further include a lever and a mechanism for operating the lever. The lever may be configured to slide the blade out of the housing once the lever is activated. In some embodiments, the lever may be activated with a push button. For example, a user may push a push button with their thumb and/or fingers that will lift the lever and slide the blade out, and when the thumb and/or fingers are lifted off the button, the biasing element will retract the blade back inside the housing. The push button may be configured into the housing and conveniently located for a thumb and/or fingers to reach. In some embodiments, the lever may be activated with a sliding mechanism. For example, a user may slide a protrusion configured in the housing and conveniently located for a thumb and/or fingers to reach and move. Once the thumb and/or fingers are lifted off the sliding protrusion, the biasing element will retract the blade back inside the housing.

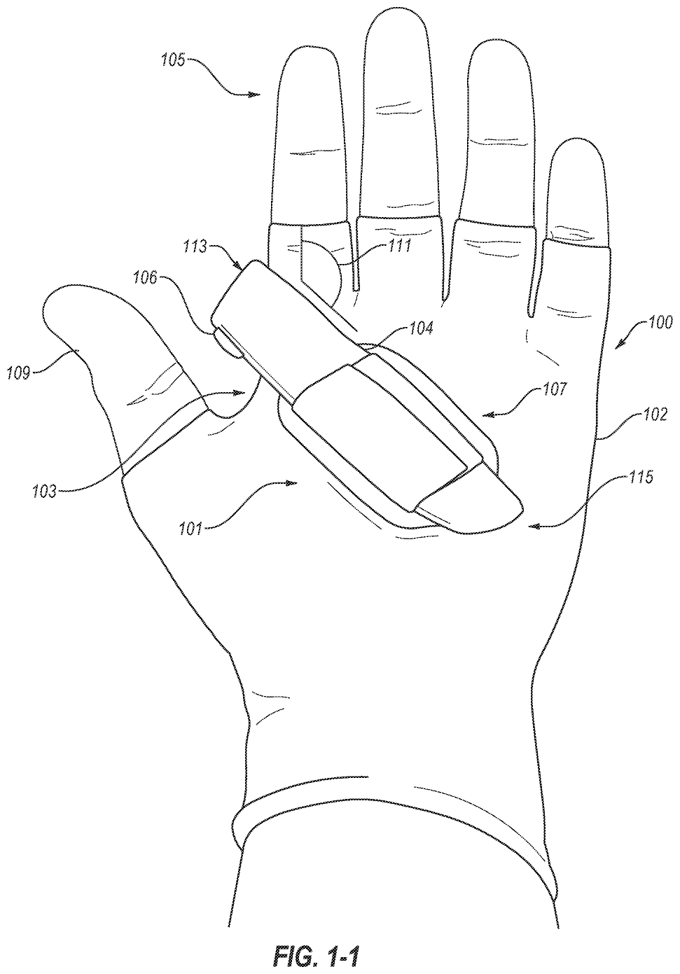

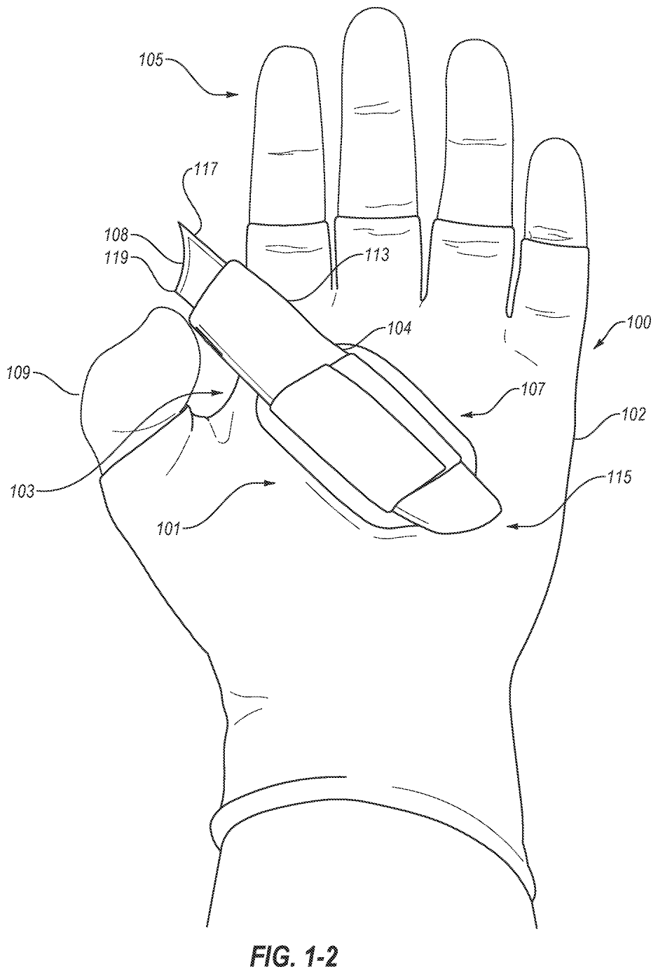

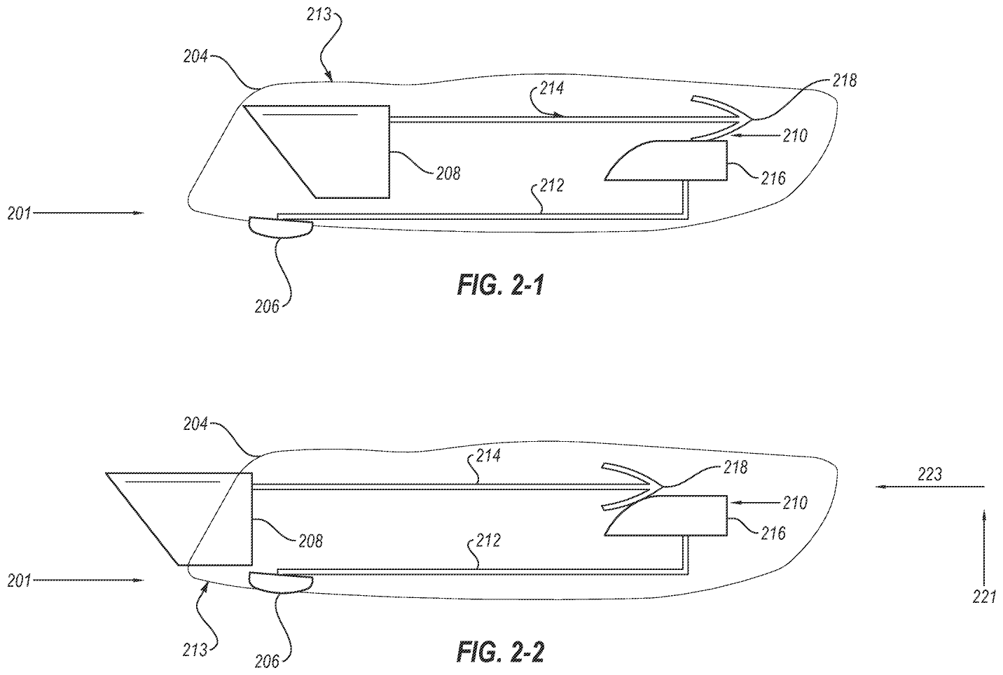

FIG. 1-1 and FIG. 1-2 show a plan view of a personal safety device 100, according to at least some embodiments of the present disclosure. The personal safety device 100 may include a wearable garment 102. Connected to the wearable garment is a bladed apparatus 101 having a blade 108 and a housing 104, wherein the housing 104 may be connected to an outside surface of the wearable garment 102. In some embodiments, the housing 104 may be rigidly fixed to the outside surface of the wearable garment 102. The wearable garment 102 may be a glove, or other type of garment worn on or around a hand or a palm. In the views shown in FIG. 1-1 and FIG. 1-2, the wearable garment 102 covers all of a user's fingers 105 fully. For example, the fingers 105 may extend from a webbing 103 of the user's hand to the tip of the user's fingers 105. In some embodiments, fingers on the glove may extend over a portion of the user's finger. For example, the fingers may have half-finger coverage, may extend to the first knuckle, the second knuckle, or any location in between. In some embodiments, the fingers on the glove may provide fingerless coverage. For example, the fingers on the glove may not extend past the webbing between two user's fingers, may not extend to the first knuckle, or may be otherwise fingerless. In some embodiments, the glove may include any combination of at least two of full finger coverage, half-finger coverage, and fingerless coverage. For example, full finger coverage may provide better grip on objects, or provide better protection against cold weather. Half-finger coverage and fingerless coverage may be more comfortable in warm weather.

In some embodiments, the housing 104 may be rigidly fixed to the garment 102. For example, the housing 104 may be connected to the garment 102 with a hook and loop connector, such as a Velcro connection. In some embodiments, the housing 104 may be fixed to the garment 102 with a means for fixing the housing 104 to the garment 102, the means for fixing the housing to the garment including Velcro, a snap connector, a button, a zipper, an adhesive, any other fastener, and combinations thereof.

In the embodiment shown in FIG. 1-1 and FIG. 1-2, the housing 104 is generally fixed on a palm side of a hand. For example, the housing 104 is connected to a palm 107 of the garment 102. Connecting the housing 104 to the palm 107 of the garment 102 may allow the user to securely grip the housing 104 in his or her hand while wearing the garment 102. This may allow the user to direct the placement and orientation of the housing 104 and the retractable blade 108 during use.

In some embodiments, the housing 104 may be oriented tilted in relation to the fingers 105 and substantially parallel to the thumb 109. The orientation of the housing 104 may allow the user's fingers 105 to easily curl into a fist, with the housing 104 nestled in the palm 107 between the fingers 105 and the palm 107. Another benefit of the orientation of the housing 104 is that it may allow the user to quickly engage to employ the blade 108. Another benefit of the orientation of the housing 104 is that it may prevent a user from accidentally cutting themselves while the blade 108 is in extended position, as shown in FIG. 1-2. In some embodiments, a housing angle 111 between the fingers 105 and the housing 104 may be 135 degrees. In some embodiments the housing angle 111 between the fingers 105 and the housing 104 may be 100 degrees. In some embodiments the housing angle 111 between the fingers 105 and the housing 104 may be 160 degrees. In some embodiments the housing angle 111 between the fingers 105 and the housing 104 may vary between 100 degrees and 160 degrees.

In some embodiments, the housing 104 may include a push button 106. The push button 106 may be conveniently located for the thumb 109 and/or fingers 105 of the user's hand to reach. For example, when the user is wearing the garment 102 on his or her hand, the user may be able to push on the push button 106 with his or her thumb 109 while gripping the housing 104. In some examples, the user may be able to push on the push button 106 with his or her fingers 105 while gripping the housing 104. As shown in FIG. 1-1, the push button 106 is located at the front-part of the housing 113. In some embodiments, the push button may be located at the back-part of the housing 115. In some embodiments the push button may be located in between the front-part of the housing 113 and the back-part of the housing 115. This may allow the user to engage the blade 108 with one hand. Based on the simple, one-handed operation of the blade 108, the user may swiftly engage the blade 108, even while under the stressful situation of an assault from an assailant.

In the view shown in FIG. 1-1, the housing 104 has a blade 108 in a retracted position. The user may push down the push button 106 to reveal the blade 108 that is disposed in the housing 104. When the user reveals the blade 108, the blade 108 may extend out of the housing 104 into an extended position shown in FIG. 1-2. In some embodiments, when the blade 108 is extended, the user may use the blade 108 to deter an assailant from harming him or her. For example, if an assailant is grappling with the user, the user may reach his or her hand behind the assailant and rake the blade 108 across the assailant's back. This may cause the assailant some amount of pain, resulting in the assailant stopping the assault on the user.

According to some embodiments, the blade 108 may have only two sharp sides. For example, in FIG. 1-2 the blade 108 may have a sharp side 117 on the side that faces fingers 105 and a sharp side 119 on the side that faces thumb 109. According to some embodiments, the blade 108 may have only one sharp side (e.g., a single sharp side). For example, the blade 108 may only have a single sharp side (e.g., sharp side 117 or sharp side 119). As shown in FIG. 1-2, one sharp side 117 is straight and one sharp side 119 is curved. In some embodiments, both sharp sides 117, 119 may be straight or both sharp sides 117, 119 may be curved. In some embodiments, the blade may have a hooked edge.

FIG. 2-1 is a representation of a cross-sectional view of a housing 204 of a bladed apparatus 201 according to at least some embodiments of the present disclosure. The housing 204 has a retractable blade 208 in retracted position positioned in the front-part of the housing 213. FIG. 2-2 is a representation of the bladed apparatus 201 of FIG. 2-1 with the retractable blade 208 in an extended position. As may be seen, in the retracted position, the retractable blade 208 is located entirely within the housing 204. For example, in the retracted position, no portion of the retractable blade 208 may extend out of the housing 204. In the extended position, at least a portion of the retractable blade 208 may extend out of the housing 204. Put another way, the retractable blade 208 may be configured to protrude outside of the housing 204 when in extended position.

In some embodiments, the bladed apparatus 201 includes a lever mechanism 210. A push button 206 may be used to operate the lever mechanism 210. The lever mechanism 210 may be configured to slide the blade 208 out of the housing 204 once the lever mechanism 210 is activated. In the embodiment shown, the lever mechanism 210 may be activated with a push of the push button 206.

The lever mechanism 210 includes a first lever 212 linked to the push button 206, and a second lever 214 linked to the retractable blade 208. The first lever 212 may include a rounded head 216. When the rounded head 216 is pushed in the first direction 221, the rounded head 216 will push on a camming surface 218 of the second lever 214. This may cause the second lever 214 to move in the second direction 223. The second lever 214 may be connected to the retractable blade 208. When the second lever 214 is moved in the second direction 223, the second lever 214 may push the retractable blade 208 in the second direction 223. In some embodiments, the movement of the second lever 214 and the retractable blade 208 may move the retractable blade 208 out of the housing 204. When the push button 206 is released a biasing element (shown in FIG. 3-1 and FIG. 3-2) may retract the blade 208 back inside the housing 204.

FIG. 3-1 and FIG. 3-2 show a cross-sectional view of a housing 304 of a bladed apparatus 301 according to at least some embodiments of the present disclosure. In the embodiment shown, a sliding mechanism is provided. A protrusion 320 is rigidly fixed to a base 322 of a blade 308. The base 322 is fixed to a back-part 315 of the housing 304 via a biasing element 324. The base 322 may be fixed to a first end 325 of the biasing element 324, and a second end 327 of the biasing element 324 may be fixed to the back-part 315 of the housing 304. The protrusion 320 extends outside of the housing 304 through a groove (not shown). In some embodiments, the protrusion will extend outside of the garment. A user may move the blade 308 between retracted position to extended position by sliding the protrusion 320 in the second direction 323. Once a user stops applying force on the protrusion 320 the biasing element 324 may retract the blade 308 back inside the housing 304. The protrusion 320 may be conveniently located for a thumb and/or fingers of the same hand to reach and slide in the groove. The blade as shown in FIGS. 3-1 and 3-2, may have a hooked edge. In some embodiments, a hooked edge on the blade 308 may help to better engage with an assailant's skin during self-defense.

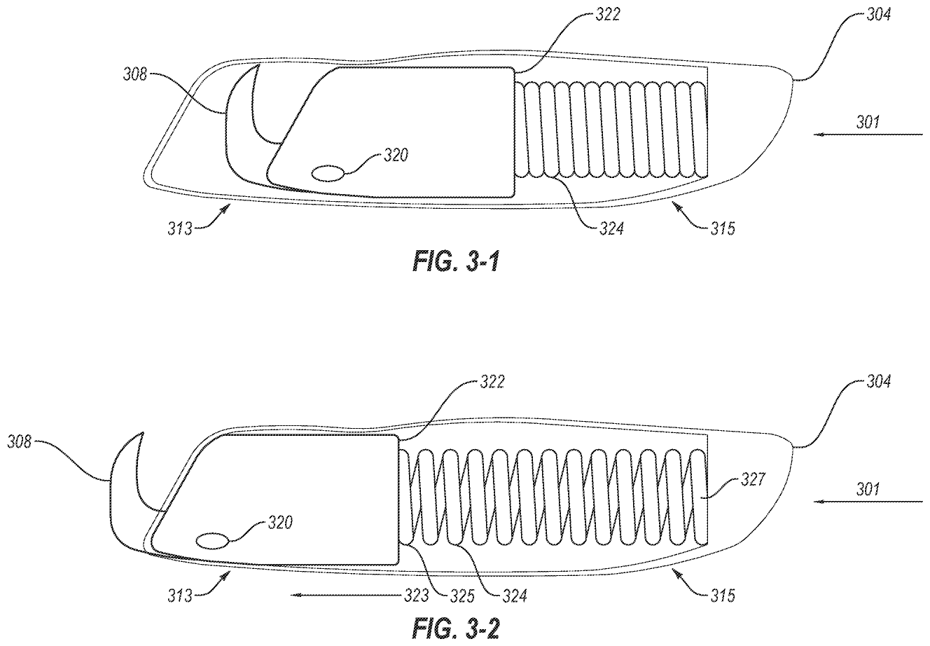

In some embodiments, the biasing element 324 may be disposed in the housing 304 and may bias the retractable blade 308 to the retracted position. For example, the biasing element 324 may be a compression spring, extension spring, torsion spring, constant force spring, coil spring, leaf spring, or other type of spring. In the embodiment shown in FIG. 3-1, the biasing element 324 is a pre-compressed spring positioned at the back-part 315 of the housing 304 and providing biasing force to the blade 308 to keep it inside of the housing 304. In another example, the biasing element 324 may be a pre-extended spring positioned at the front-part of the housing 304 and providing biasing force to the blade 308 to keep it inside of the housing 304. In both examples, the biasing element 324 applies a force to the blade 308 toward the back-part 315 of the housing 304.

In some embodiments, the biasing element is a system of magnets. For example, the biasing element may include a first magnet located at the back-part of the housing and having its positive pole against the back-part of the blade, wherein the blade may have a second magnet having its negative pole against the first magnet. The biasing element may further include a third magnet located at the front-part of the blade having its positive pole against the front-part of the housing, wherein the front-part of the housing may include a fourth magnet having its positive pole against the front-part of the blade. The resulting system of magnets providing magnetic repulsion force for moving the blade to extended position and attraction force for moving the blade to retracted position.

In some embodiments the biasing element may be a compressible gas in a cylinder positioned at the front-part of the housing and providing a biasing force towards the blade. As the gas in the cylinder is compressed, the pressure in the cylinder increases, providing an increasing force from the biasing element.

In some embodiments, the biasing element may follow Hooke' s law and exhibit a linear force response to displacement along a longitudinal axis of the biasing element. In some embodiments, the biasing element has an exponential biasing force vs. displacement curve. For example, the biasing element may include a progressive spring, a compressible gas, or other material that causes the force generated by the biasing element to increase exponentially relative to the displacement along a longitudinal axis of the biasing element.

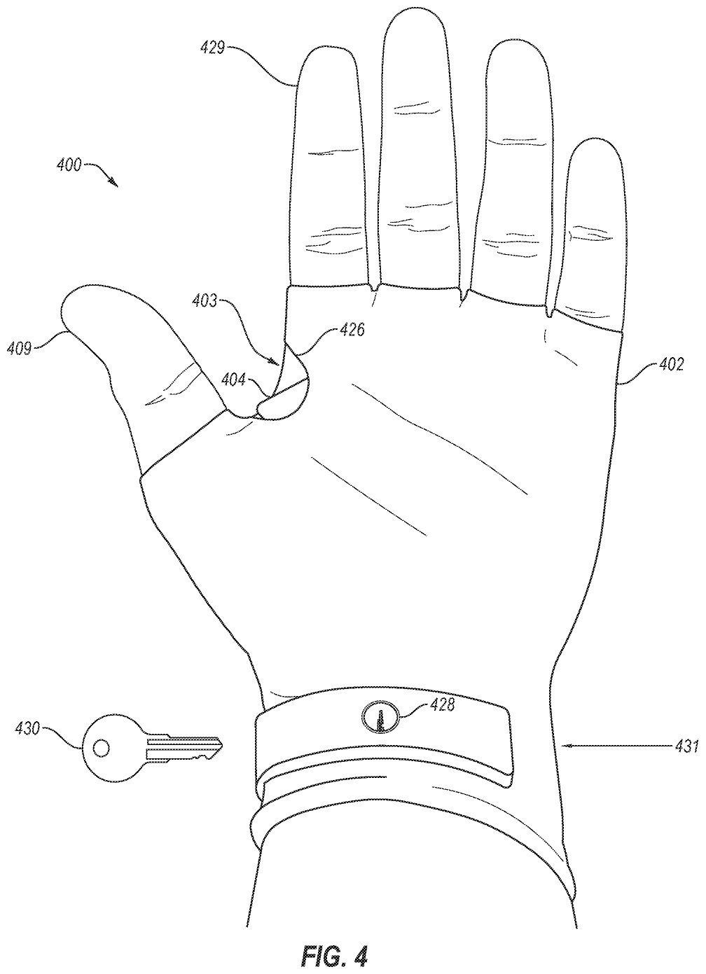

FIG. 4 is a representation of an embodiment of a personal safety device 400, according to at least some embodiments of the present disclosure. The personal safety device 400 may include a fingerless glove 402 including a pocket for a housing 404. The fingerless glove 402 may have an opening 426 substantially on the webbing area of the palm 403, between thumb 409 and index finger 429, and may allow the blade within the housing 404 to protrude outside of the housing 404 through the opening 426 when in extended position. The housing 404 and the angle of the opening, according to some embodiments, may help to prevent injuring oneself even when the blade is in extended position.

The housing 404, in FIG. 4, is completely secured inside the pocket (e.g., no portion of the housing 404 extends out of the interior of the fingerless glove 402). In some embodiments, the housing 404 may protrude outside of the pocket. In one example, the housing 404 may be rigidly fixed inside the pocket to prevent the housing 404 from being removed. In some embodiments, the rigidly fixed housing 404 may be removably disposed in the pocket. In some embodiments, the rigidly fixed housing 404 may only be removed inside of the pocket when the glove 402 is removed. In FIG. 4 the glove 402 is secured to its place with a mechanical lock 428 on the wrist area 431. The mechanical lock 428 may only be opened with a key 430. The mechanical lock 428 may be located at a palm side of the wrist, at a back side of the wrist, or in between the palm side of the wrist and the back side of the wrist.

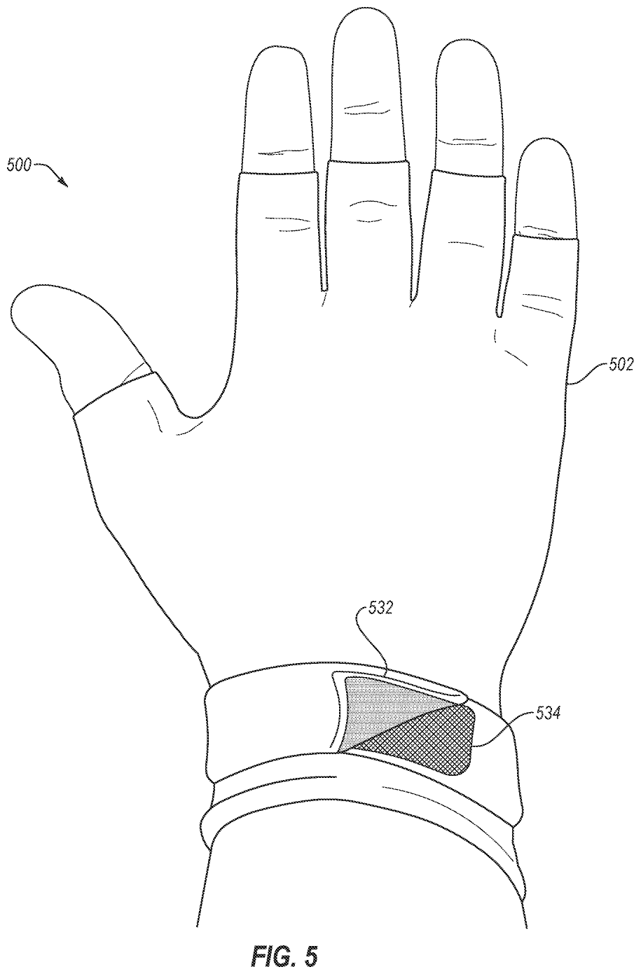

FIG. 5 is a representation of an embodiment of a personal safety device 500, according to at least some embodiments of the present disclosure. The personal safety device 500 includes a half-finger glove 502 secured to the hand and wrist with a hook and loop connector. First side of the connector 532 includes the hooks and the second side of the connector 534 includes the loops. In some embodiments, the first side of the connector 532 includes the loops and the second side of the connector 534 includes the hooks. One example of a hook and loop connector is Velcro.

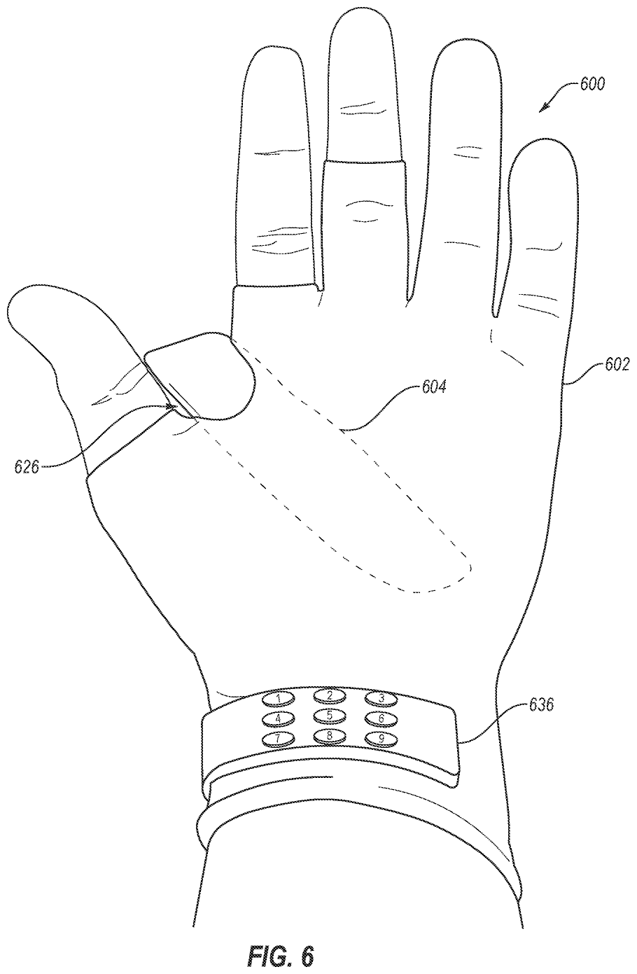

FIG. 6 is a representation of an embodiment of a personal safety device 600, according to at least some embodiments of the present disclosure. The personal safety device 600 includes a glove 602 having a full-finger coverage in a ring finger and little finger, a half-finger coverage in middle-finger and fingerless coverage in index finger and thumb. The glove 602 further includes a pocket for a housing 604 wherein the housing 604 may protrude outside of an opening 626 in the glove 602. In some embodiments, the opening prevents the handle from coming out of the pocket. The personal safety device 600 is secured to the hand and wrist with a digital code lock 636. The personal safety device 600 may only be removed from the hand/wrist by inserting a correct PIN code to the digital code lock 636.

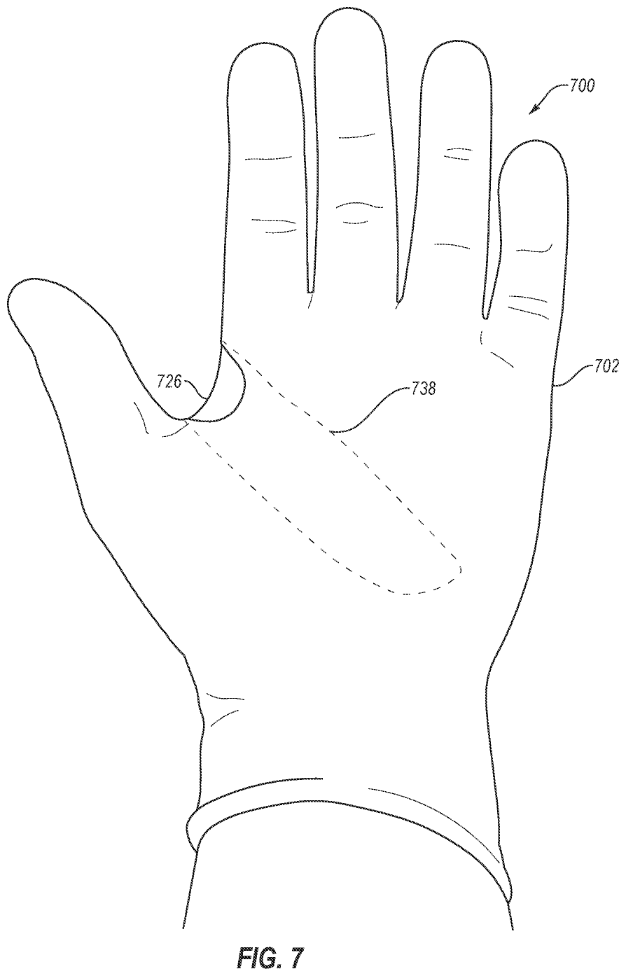

FIG. 7 is a representation of an embodiment of a personal safety device 700, according to at least some embodiments of the present disclosure. The personal safety device 700 may include a glove 702 having a pocket 738 for a housing, and an opening 726 for the housing or a blade to protrude out. The housing may be attached inside the pocket 738 with a hook and loop connector solution.

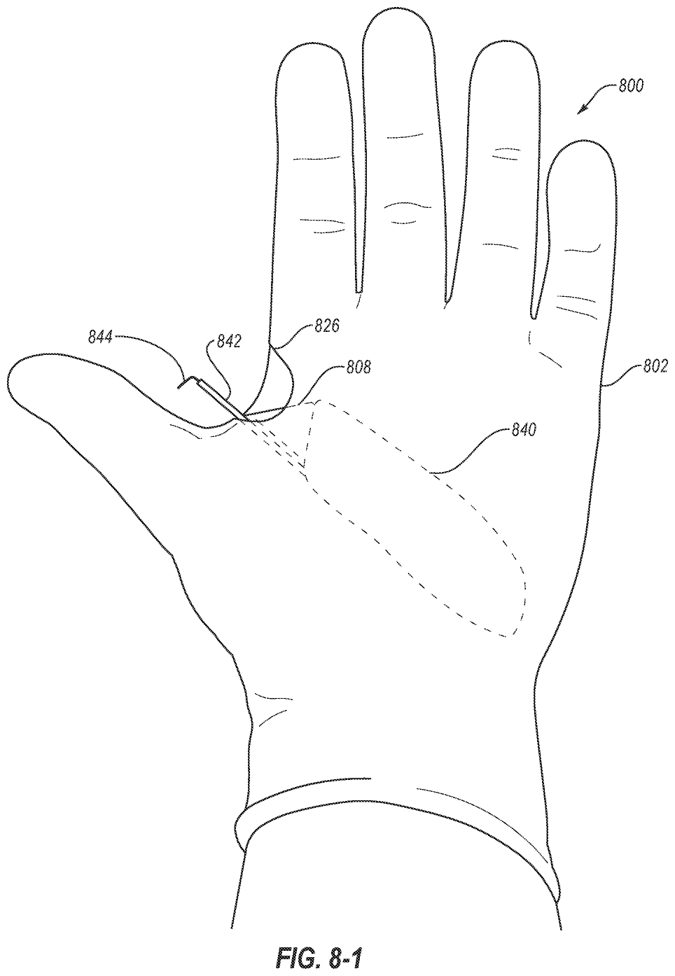

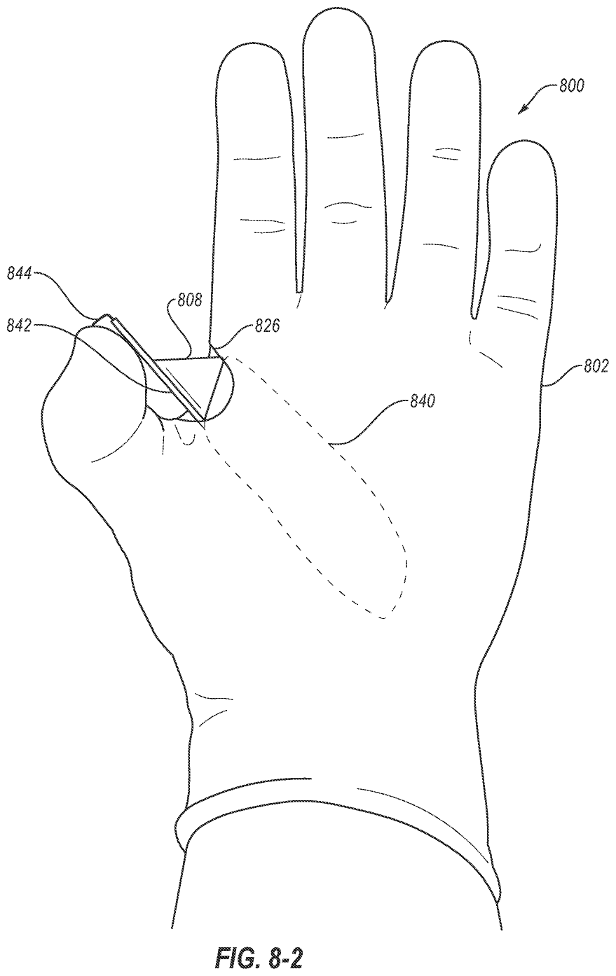

FIGS. 8-1 and 8-2 are a representation of an embodiment of a personal safety device 800, according to at least some embodiments of the present disclosure. The personal safety device 800 may include a glove 802 having a pocket for a blade 808, wherein the blade 808 is attached to a handle 840 having a lever arm 842. The lever arm 842 being visible outside of the pocket through an opening 826 when the blade 808 is hidden in the pocket, and when the blade 808 is extracted out of the pocket. In some embodiments, the blade 808 and the handle 840 are displaced in a housing and the housing is attached to the glove 802. A user may use the lever arm 842 to manually pull the blade 808 out of the pocket or out of the housing. The handle 840 of the blade 808 may prevent the user from removing the handle 840 outside of the opening 826 and/or the housing. The opening 826 may be only big enough for the blade 808 to travel through but will prevent the handle 840 from coming through. Similarly, the housing opening 826 may be only big enough for the blade 808 to travel through but will prevent the handle 840 from coming through. In some embodiments the lever arm 842 may include a hooked head 844 for easier pull.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. An apparatus for personal safety, comprising;
a wearable garment including:
a palm portion;
a thumb portion connected to the palm portion; and
an index portion connected to the palm portion;
a housing connected to the wearable garment at the palm portion, the housing having an opening positioned between the thumb portion and the index portion;
a retractable blade disposed in the housing, wherein the retractable blade has a retracted position and an extended position, and wherein in the extended position, the retractable blade protrudes through the opening; and
a biasing element disposed in the housing, the biasing element biasing the retractable blade to the retracted position.

2. The apparatus of claim 1, wherein the wearable garment is a glove.

3. The apparatus of claim 2, wherein the glove includes at least one of full finger, half-finger, or fingerless coverage.

4. The apparatus of claim 2, wherein the glove further includes a pocket disposed on the palm portion of the glove.

5. The apparatus of claim 4, wherein the housing is disposed in the pocket.

6. The apparatus of claim 1, wherein the housing is rigidly connected to the wearable garment with a hook and loop connector.

7. The apparatus of claim 1, wherein the housing is positioned such that the opening in the housing is beyond the palm portion.

8. The apparatus of claim 1, wherein the housing is removably connected to the wearable garment.

9. The apparatus of claim 1, wherein the retractable blade is disposed substantially parallel to a palm.

10. The apparatus of claim 1, wherein the retractable blade has at least one of one sharp side, two sharp sides, one curved sharp side, one straight sharp side, or a hooked edge.

11. The apparatus of claim 1, wherein the wearable garment is secured to a user's wrist with at least one of a hook and loop connector, a mechanical lock, and a digital code lock.

12. The apparatus of claim 1, further comprising a lever mechanism for sliding the retractable blade out of the housing.

13. The apparatus of claim 12, further comprising a button for activating the lever mechanism.

14. The apparatus of claim 12, wherein the biasing element applies an increased biasing force on the retractable blade towards a back-part of the housing when the lever mechanism is activated.

15. The apparatus of claim 2, further comprising:
a lever arm attached to the retractable blade, wherein the lever arm protrudes outside of the housing when the retractable blade is in retracted position.

16. The apparatus of claim 1, wherein the opening in the housing prevents an entirety of the retractable blade from coming out of the housing.

17. The apparatus of claim 15, wherein the retractable blade is displaced in a housing, and wherein the housing is displaced in a pocket.

18. A method for activating a personal safety device, comprising:
activating a lever mechanism for sliding a retractable blade out of an opening in a housing, wherein the housing is attached to a wearable garment, wherein the opening in the housing is positioned between a thumb portion and an index portion of the wearable garment, and wherein activating the lever mechanism extends a biasing element; and
retracting the retractable blade inside the housing when the lever mechanism is deactivated, wherein the biasing element is biasing the retractable blade to a retracted position.

19. The method of claim 18, wherein the lever mechanism is activated with a push of a push button.

20. The method of claim 18, wherein the lever mechanism is activated with a sliding mechanism.

21. The apparatus of claim 1, wherein the biasing element provides a biasing force to the retractable blade to retain the retractable blade within the housing in the retracted position.

22. The apparatus of claim 5, further comprising a lever mechanism for sliding the retractable blade out of the housing, the lever mechanism being activated by a button, and wherein the button protrudes outside of the pocket when the retractable blade is in the retracted position.

23. The apparatus of claim 1, further comprising a lever mechanism activated by a button for sliding the retractable blade out of the housing, the button being oriented toward a wrist portion of the wearable garment, or the thumb portion.

24. The apparatus of claim 1, further comprising a lever mechanism activated by a button for sliding the retractable blade out of the housing, the button being positioned adjacent the opening in the housing.

25. The apparatus of claim 1, wherein the biasing element further comprises a spring connected to the retractable blade and grounded to a base of the housing, the base being located on an opposite side of the housing from the opening of the housing, and wherein the spring pulls the retractable blade toward the base of the housing.

26. An apparatus for personal safety, comprising;
a wearable garment including:
a palm portion;
a thumb portion connected to the palm portion; and
one or more finger portions connected to the palm, the one or more finger portions including an index finger portion;
a housing connected to the wearable garment at the palm portion, wherein the housing is nestled between the palm portion and the one or more finger portions, wherein the housing is positioned substantially parallel to the thumb portion, and wherein the housing has an opening positioned between the thumb portion and the index portion;
a retractable blade disposed in the housing, wherein the retractable blade has a retracted position and an extended position, and wherein in the extended position, the retractable blade protrudes through the opening; and
a biasing element disposed in the housing, the biasing element biasing the retractable blade to the retracted position.
